(19) United States
(12) Patent Application Publication
(10) Pub. No.: US 2008/0263880 A1
(43) Pub. Date: Oct. 30, 2008

(54) Protractor level

(76) Inventor: Christopher L. Hess, Halifax, NC (US)

Correspondence Address: JAMES RAY & ASSOCIATES, 2640 PITCAIRN ROAD, MONROEVILLE, PA, 15146, US

(21) Appl. No.: 12/082,005

(22) Filed: Apr. 8, 2008

Related U.S. Application Data
(60) Provisional application No. 60/911,947, filed on Apr. 16, 2007.

(51) Int. Cl. G01C 9/06

(52) U.S. Cl. 33/366.11

(57) ABSTRACT

An apparatus for determining a proper level of an item on any surface. The apparatus comprises a frame member having a predetermined shape and formed of a predetermined material. A first LED readout is disposed in the frame member for determining a level in a vertical direction and a second LED readout is disposed in the frame member closely adjacent to the first LED readout for determining a level in a horizontal direction. There is at least at least one magnet disposed on a bottom portion of the frame member for holding the frame member against a metal surface and such frame member has a counterweight disposed therein for offsetting the weight of the LED readouts. A power means is in electrical communication with the first and the second LED readouts and is disposed in a back portion of the frame members and a switch means is disposed in the frame member and is in electrical communication with the power means and such first and second LED readouts for turning the apparatus either on or off.

### CROSS REFERENCE TO RELATED APPLICATIONS

This application is closely related to and claims benefit from U.S. Provisional Application Ser. No. 60/911,947 filed Apr. 08, 2007

### FIELD OF THE INVENTION

The present invention relates, in general, to a level, and, more particularly, the present invention relates to a protractor level that facilitates the process of reading a level by displaying the degree of level by digital numbers.

### BACKGROUND OF THE INVENTION

Frequently it is difficult to operate and accurately read a traditional bubble level. The bubble is constantly moving and without an actual number there is room for human error in reading where the bubble is perfectly centered. In many situations, like household renovations or hanging a shelf or a wall ornament, the user may not require an exact degree measurement to insure a level surface, but for construction purposes if the level is not accurate items could be built improperly, which could cost the company money in compensation or repair.

Thus, it would be advantageous if there were a means or apparatus which could accurately measure a level with a digital readout in degrees to ensure that the measurement is level.

### SUMMARY OF THE INVENTION

The present invention provides an apparatus for determining a proper level of an item on any surface, the apparatus comprises a frame member having a predetermined shape and formed of a predetermined material. A first LED readout is disposed in the frame member, such first LED readout is for determining a level in a vertical direction. A second LED readout is disposed in the frame member closely adjacent to the first LED readout for determining a level in a horizontal direction. There is at least at least one magnet disposed on a bottom portion of the frame member for holding the frame member against a metal surface. The frame member has a counterweight disposed therein on an opposite end as such first and second LED readouts for offsetting the weight of the first and second LED readouts. A power means is in electrical communication with the first and the second LED readouts and is disposed in a back portion of the frame member for providing power to such LED readouts and a switch means is disposed in the frame member and is in electrical communication with the power means and such first and second LED readouts for turning the apparatus either on or off.

### OBJECTS OF THE INVENTION

It is, therefore, one of the primary objects of the present invention to provide an easy to read level that translates into protractor degrees in digital numbers.

Another object of the present invention is to provide a protractor level that is able to accurately determine the proper level of any item on any surface.

Still another object of the present invention is to provide a protractor level that will eliminate the guesswork employed when using a traditional bubble level.

Yet another object of the present invention is to provide a protractor level that enables a person to level two sides of an object even on an uneven surface.

In addition to the various objects and advantages of the invention which have been described in some specific detail above it should be noted that various other objects and advantages of the present invention will become more readily apparent to those persons who are skilled in the relevant art from the following more detailed description, particularly when such description is taken in conjunction with the appended claims.

### BRIEF DESCRIPTION OF THE DRAWINGS

FIG. 1 is a front view of the protractor level according to an embodiment of the invention.

FIG. 2 is a view of a bottom portion of the level showing the magnets used for securing to a surface.

FIG. 3 is a back view of the protractor level shown in FIG. 1.

FIG. 4 is a block diagram of the electrical system of the protractor level shown in FIG. 1.

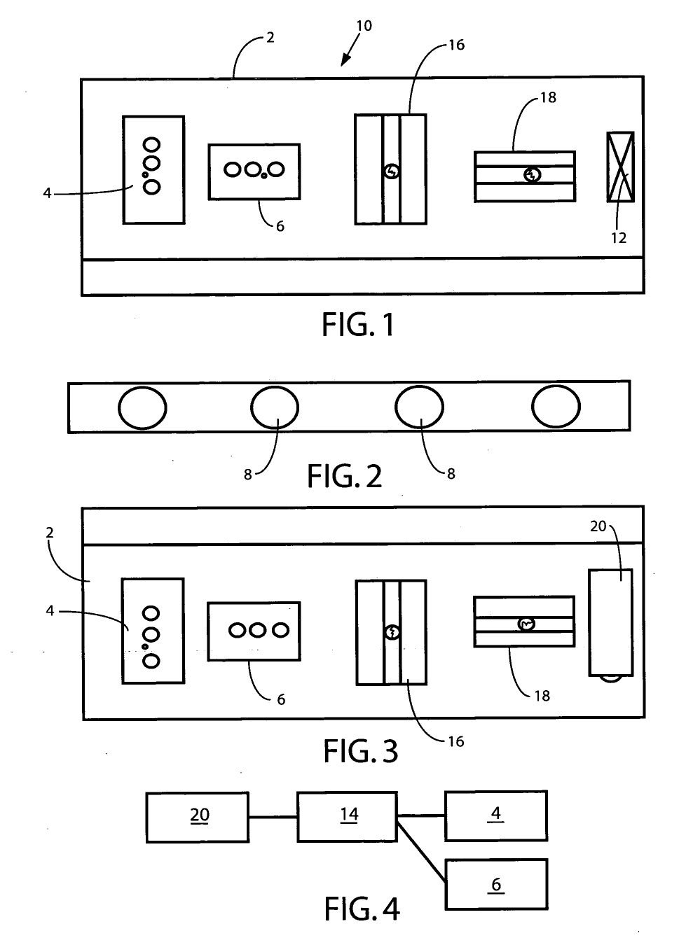

### BRIEF DESCRIPTION OF THE PRESENTLY PREFERRED AND VARIOUS ALTERNATIVE EMBODIMENTS OF THE INVENTION

Prior to proceeding with the more detailed description of the present invention it should be noted that, for the sake of clarity, identical components which have identical functions have been designated by identical reference numerals throughout the several views illustrated in the drawings.

In a first aspect the present invention provides an apparatus, generally designated 10, for determining a proper level of an item on any surface, the apparatus 10 comprises a frame member 2 having a predetermined shape and formed of a predetermined material. A first LED readout 4 is disposed in the frame member 2, such first LED readout 4 is for determining a level in a vertical direction. A second LED readout 6 is disposed in the frame member 2 closely adjacent to the first LED readout 4 for determining a level in a horizontal direction. There is at least at least one magnet 8 disposed on a bottom portion of the frame member 2 for holding the frame member against a metal surface. The frame member 2 has a counterweight disposed therein on an opposite end as such first and second LED readouts, 4,6 for offsetting the weight of the first and second LED readouts 4,6. A power means generally designated 20 is in electrical communication with the first and the second LED readouts 4,6 and is disposed in a back portion of the frame member 2 for providing power to such LED readouts 4,6 and a switch means 14 is disposed in the frame member 2 and is in electrical communication with the power means 20 and such first and second LED readouts 4,6 for turning the apparatus 10 either on or off. 2.

The frame member 2 further includes a first standard bubble level 16 for determining a level in a vertical direction and a second standard bubble level 18 for determining a level in a horizontal direction so that the apparatus 10 could be used as a traditional bubble level. These two traditional bubble levels 16, 18 are provided in the event that the battery goes bad while in use or in the case where the user prefers the bubble level.

Such power means 20 in the apparatus includes at least one battery. It is presently preferred that such apparatus 10 includes at least one AA battery.

Such LED readouts 4,6 (liquid emitting diodes)are digital readouts and use protractor degrees that range from 0.0 to 99.9 which makes it easy to determine the level. Of the unit.

It is also presently preferred that such predetermined material for forming the frame member 2 is selected from one of metal and plastic and it is preferred that the material is metal and, further, that such metal is aluminum because it is lightweight and possesses sufficient strength for the use.

While a presently preferred embodiment and alternate embodiments of the present invention have been described in detail above, it should be understood that various other adaptations and/or modifications of the invention can be made by those persons who are particularly skilled in the art without departing from either the spirit of the invention or the scope of the appended claims.

I claim:

1. An apparatus for determining a proper level of an item on any surface, said apparatus comprising:
(a) a frame member having a predetermined shape and formed of a predetermined material;
(b) a first LED readout disposed in said frame member, said LED readout for determining a level in a vertical direction;
(c) a second LED readout disposed in said frame member closely adjacent to said first LED readout for determining a level in a horizontal direction;
(d) at least one magnet disposed on a bottom portion of said frame member for holding said frame member against a metal surface;
(e) a counterweight disposed in said frame member on an opposite end as said first and said second LED readouts for offsetting a weight of said first and said second LED readouts;
(f) a power means in electrical communication with said first and said second LED readouts disposed in a back portion of said frame member for providing power to said LED readouts; and
(g) a switch means in electrical communication with said power means and said first and said second LED readouts for turning said apparatus one of on and off.

2. The apparatus, according to claim 1, wherein said frame member further includes a first standard bubble level for determining a level in a vertical direction.

3. The apparatus, according to claim 2, wherein said frame member further includes a second standard bubble level for determining a level in a horizontal direction.

4. The apparatus, according to claim 1, wherein said power means includes at least one battery.

5. The apparatus, according to claim 4, wherein said at least one battery is a AA battery.

6. The apparatus, according to claim 1, wherein said LED readout and said second LED readout are digital readouts.

7. The apparatus, according to claim 6, wherein said digital readouts use protractor degrees that range from 0.0 to 99.9.

8. The apparatus, according to claim 1, wherein said predetermined material is selected from one of metal and plastic.

9. The apparatus, according to claim 8, wherein said metal is aluminum.

10. The apparatus, according to claim 1, wherein said plastic is a rigid, heavy duty plastic material
